(19) United States
(12) Patent Application Publication
(10) Pub. No.: US 2011/0305027 A1
(43) Pub. Date: Dec. 15, 2011

(54) INDUCTION STREETLIGHT

(76) Inventor: Richard Ham, Irvine, CA (US)

(21) Appl. No.: 12/797,045

(22) Filed: Jun. 9, 2010

(51) Int. Cl. F21V 21/088; F21V 29/00; F21V 15/01

(52) U.S. Cl. 362/368; 362/375; 362/373

(57) ABSTRACT

An improved streetlamp featuring separate compartments for the lamp, ballast, photocell and wiring is provided. All electrical components of the streetlight are sealed from the elements and infestation from insects such as bees and wasps. All of the compartments may be readily opened without the use of tools and each electrical component and the light-glass can be readily removed and replaced with simple hand tools. Features for improved heat transfer to the atmosphere which results in a cooler running and longer lasting lamp are also provided.

### FIELD OF THE INVENTION

The present invention relates generally to energy efficient streetlights and more particularly to an improved housing and assembly for an energy efficient streetlight wherein all major components of the lighting system may be readily removed from the housing for “in the field replacement” and wherein the housing features improved heat dissipation and isolation, among other improvements.

### BACKGROUND OF THE INFORMATION

In recent years, there have been substantial improvements in streetlight technology. Previously, high intensity discharge (“HID”) streetlights typically used mercury-vapor, high pressure sodium or metal-halide lamp technologies. Recently, newer technology electrodeless induction, LED or plasma lamps have become to be used in streetlight applications. These lamps have several advantages over older HID systems which use magnetic ballasts. In particular, the newer energy efficient technologies last 5-10 times longer, experience significantly less degradation in light output over their service lives, offer a higher quality of light and are more energy efficient.

Induction lamps do, however, have certain drawbacks, mainly higher initial cost and heat sensitive components which compromise system life and performance. However, the greatly increased service life of induction lamps over that of other HID lamps offsets the increased initial costs and the heat sensitive components used in an induction lighting system can be protected via improvements to the streetlamp housing. High temperatures affect both the electrical and lamp components typically located inside the streetlight, which in turn will reduce overall service life of the system. Reducing the operating temperature of induction lamps by dissipating heat from the lamp by way of an improved housing as well as isolating heat sensitive electrical components from the lamp can significantly extend the life of the system. Improved lamp life is an important aspect of streetlight design because streetlights are typically mounted at the top of tall light-poles, which makes servicing in the field difficult and costly.

Another important aspect of streetlight housing design is serviceability and installation. Serviceability is particularly important in streetlights because streetlights are typically located along busy roads and highways and, as mentioned, are also typically located at the top of tall light-poles. The service of streetlights poses unusual dangers to workers because the lamps are typically located at substantial heights and therefore require special equipment to reach, and are typically situated in locations exposed to the hazards of vehicular traffic. In addition, streetlights must often be serviced “live,” i.e. with the power on, because it is frequently not practical to shut off power along an entire road or freeway for the purpose of servicing one particular streetlight. Replacement of lamps and their associated electrical components, i.e. the ballast, with the power on exposes maintenance workers to yet another inherently dangerous condition. Also, not infrequently, workers servicing streetlamps face a hazard of the natural type, namely bees, wasps or other insects that have built a nest inside the streetlight housing. In view of the worker hazards involved, it is desirable that streetlights be easy and quick to service.

It is also desirable that streetlights be quickly and easily serviced due to the high costs of maintenance. The costs associated with servicing a streetlight include replacements parts costs for the lamps, electronics and glass, but more importantly include the costs of a service crew. The costs of a service crew are significant and include worker salaries, training and insurance, as well as the cost of trucks equipped with lifts capable of reaching the streetlights.

There is a need in the art for a streetlight that provides improved cooling for the newer technology induction lamps and provides improvements in the lamp housing that reduce the time required to service and install the light. Even a relatively small reduction in the time required to service an individual streetlight leads to improved worker safety and substantially decreased costs given that municipalities must service relatively large numbers of lights. Even small municipalities typically must maintain and service several hundred streetlights while large cities are faced with the task of servicing tens of thousands.

### SUMMARY OF THE INVENTION

The present invention streetlight improves upon the prior art by providing improved cooling for the newer technology induction lamps and by providing improvements in the lamp housing that reduce the time required to service the light. In its most basic form, the new streetlight comprises a main housing which includes separate, sealed, compartments for the induction lamp and the ballast or lamp electronics. Another separate compartment is provided for the photocell, the terminal block and the mast clamps. The lamp compartment of the housing features a multiplicity of heat sinks for conducting heat out of the compartment and into the housing where the heat is dissipated in the atmosphere through a combination of convection cooling and radiation. By providing separate lamp and ballast compartments, the ballast is better protected from the heat loading by the lamp. The ballast is further protected from heat by being attached to a finned heat sink (which also serves as a compartment cover). The mast clamps of the new streetlight are able accommodate a wide range of mast diameters from about 1¼″ to about 2½,″ or essentially all diameters in common use in the United States. Each of the compartments is sealed from elements and infestation from insects. In addition, the present invention streetlight includes features that allow each compartment of the light to be opened without the use of tools and the principle electrical components of the light, i.e. the lamp, ballast, and photocell can all be easily removed and replaced with simple hand tools, i.e. nothing more than a screwdriver. The light-glass which may occasionally require replacement due to breakage may also be easily removed with simple hand tools, i.e. a screwdriver.

### BRIEF DESCRIPTION OF THE DRAWINGS

FIG. 1 is a side view of the present invention streetlight.

FIG. 2 is a top plan view of the streetlight FIG. 1.

FIG. 3 is a bottom plan view the streetlight of FIG. 1.

FIG. 4 is an end view of the streetlight of FIG. 1 looking towards the end of the streetlight that is affixed to a mast or light-pole.

FIG. 5 is an end view of the streetlight of FIG. 1 looking towards the free end of the streetlight.

FIG. 6 is an end perspective view of the streetlight of FIG. 1 looking towards the end of the streetlight that is affixed to a mast or light-pole and showing the streetlight with the ballast and mast compartment covers open.

FIG. 7 is a top plan view of the streetlight of FIG. 1 showing the streetlight with the ballast and mast compartment covers open.

FIG. 8 is a side perspective view, partially exploded, of the streetlight of FIG. 1 showing the streetlight with the lamp compartment cover or lid open.

FIG. 9 is a top view of the streetlight of FIG. 1 showing the streetlight with the lamp compartment cover or lid open and with the lamp and reflector removed to reveal internal details.

FIG. 10 is a side view of an induction lamp suitable for use with the present invention streetlight of FIG. 1, showing he base supports for the induction lamp and their ribbed or finned cooling surfaces.

FIG. 11 is a top view of an induction lamp suitable for use with the present invention streetlight of FIG. 1 showing the clamp and ribbed cooling surfaces of the supports for the induction lamp.

### DETAILED DESCRIPTION OF THE PREFERRED EMBODIMENTS

The present invention will now be described more fully with reference to the accompanying drawings, in which preferred embodiments of the invention are shown. The invention may, however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

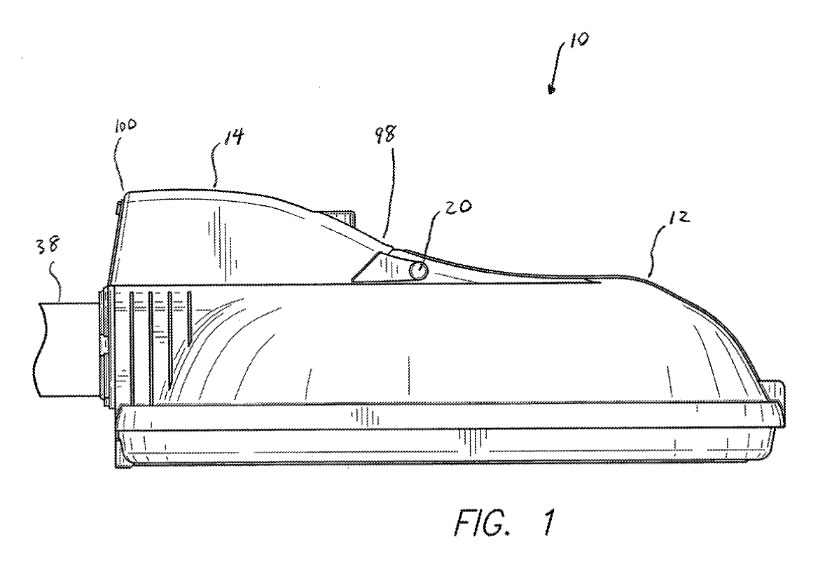

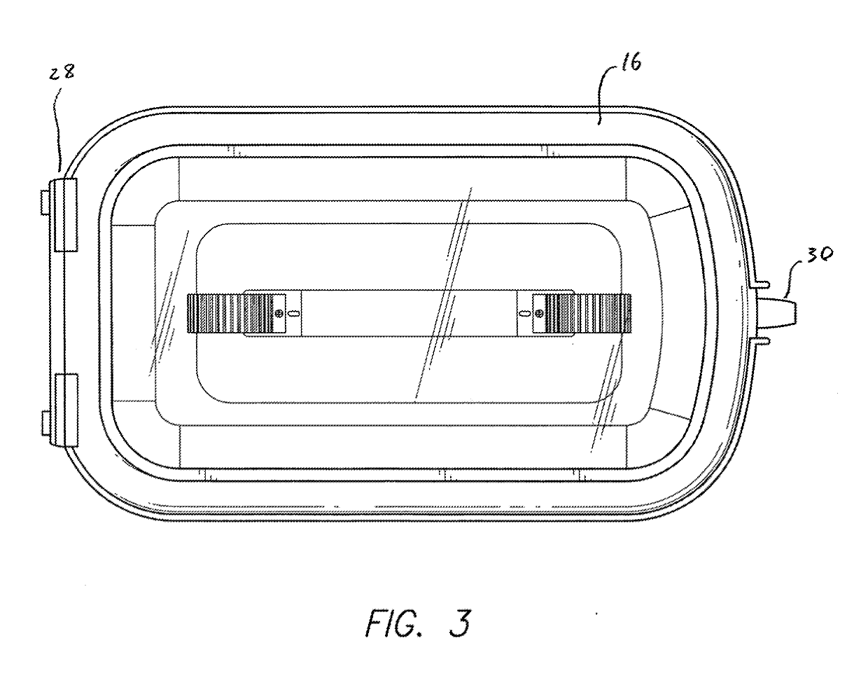

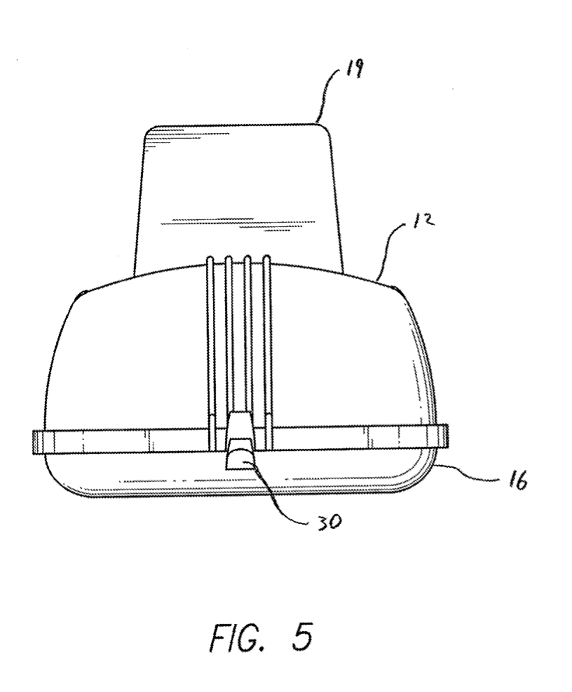

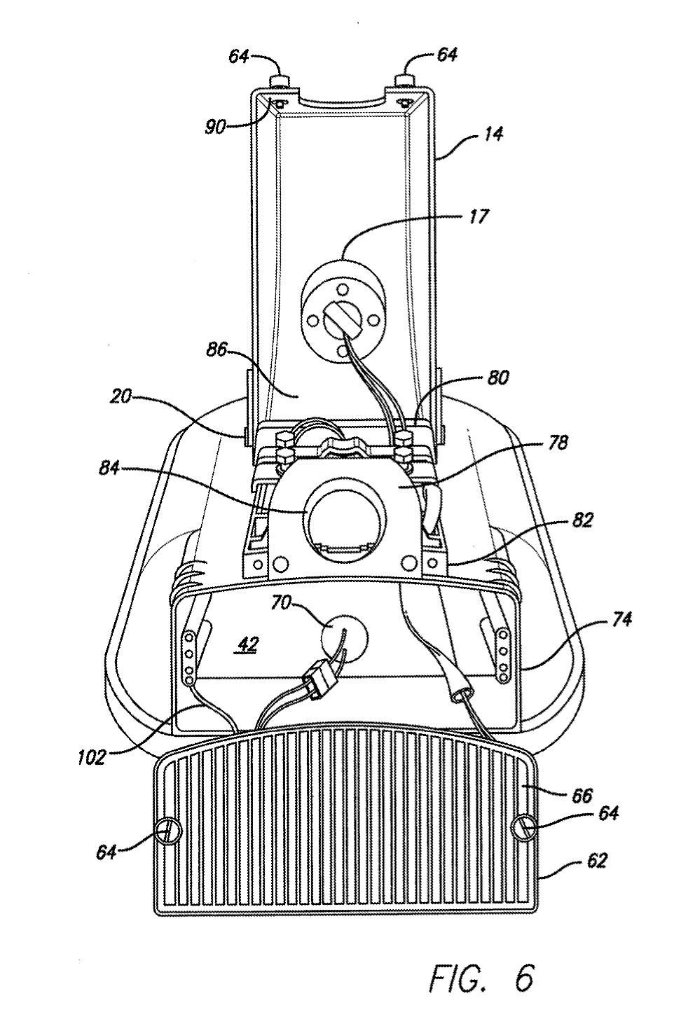

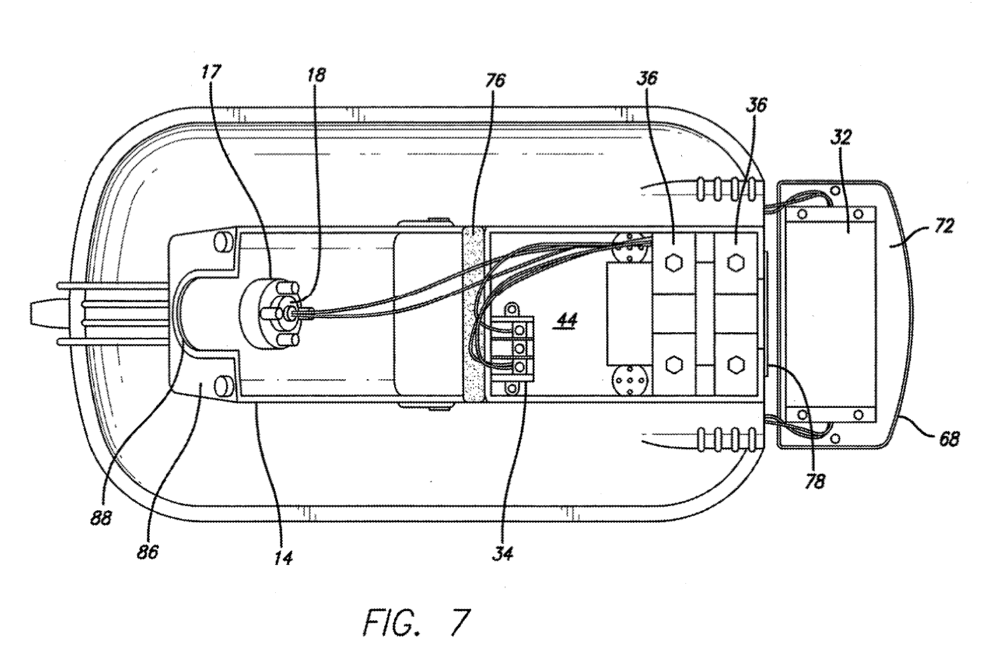

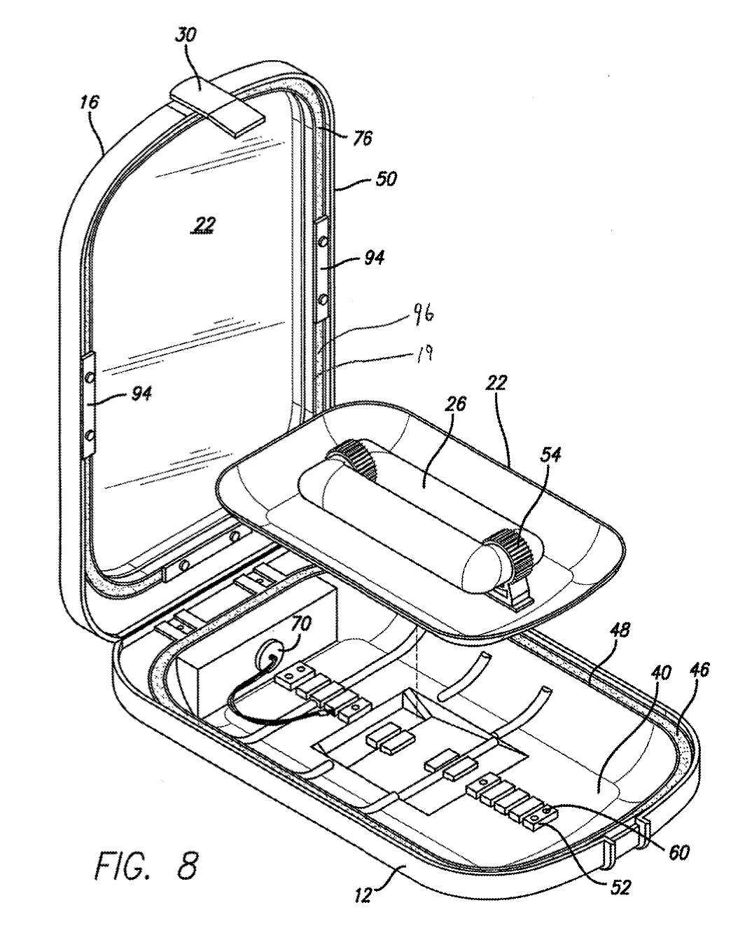

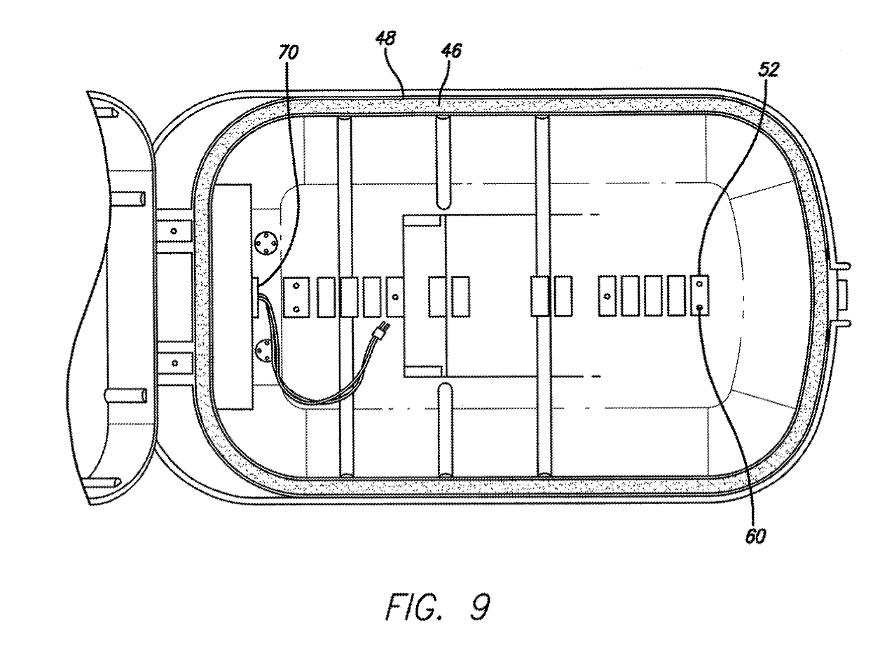

With reference to FIGS. 1 through 11, the present invention streetlight 10 includes a main housing 12 having an outer surface 13. The main housing 12 includes a lamp compartment 40 (see FIGS. 8-9), a ballast compartment 42 (see FIG. 6), and mast compartment 44 (see FIG. 7). Located within the lamp compartment 40 of the main housing 12 are a lamp 26 and a reflector 24 (see FIG. 8). Located within the ballast compartment is a ballast (lamp electronics) 32. Located within the mast compartment 44 is a photocell 18 and a terminal block 34 which interconnects the electrical wiring between the lamp 26, ballast 32 and photocell 18. (Best shown in FIG. 7.) The lamp 26, ballast 32, and photocell 18 are connected in electrical circuit and the ballast 32 is connected to an external source of electrical power which is typically introduced to the streetlight 10 through a mast 38 and light-pole (not shown) to which the streetlight 10 is connected.

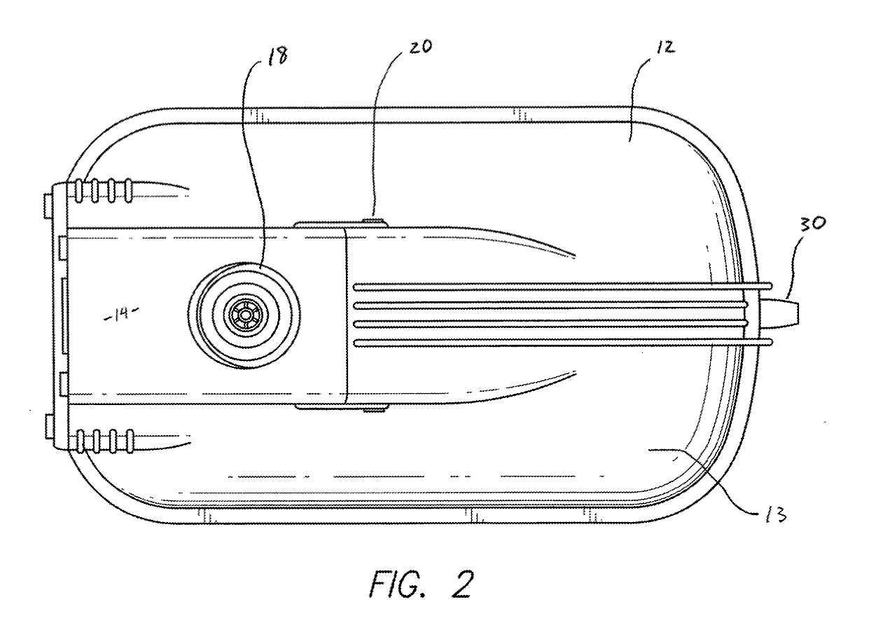

Referring now to FIGS. 2-5, and 8-9 in particular, the lamp compartment 40 is closed out by a lid 16 which is hinged to the main housing at one end by hinges 28. At the end of the lid 16 opposite the hinge, the lid 16 latches to the main housing 12 via a latch 30. Formed in the lamp compartment 40, about its periphery, is a channel 48 for the receipt of a seal 46. The channel 48 and seal 46 run the full length of the periphery of the lamp compartment 40. The lid 16 includes a sealing edge 50. When the lid 16 is closed and latched via latch 30 to the main housing 12, the sealing edge 50 contacts the seal 46 located in the lamp compartment 40 and thereby seals the lamp compartment 40 and the lamp 26 and reflector 24 contained therein from the elements, i.e. from the weather. The latch 30 allows the lid to be opened and closed without the use of tools in most instances and thereby reduces the time needed to service, i.e. change-out, the lamp.

With reference to FIG. 9, in addition to the seal 46 for the lid 16, the lamp compartment 40 of the main housing 12 also includes a plurality of reflector supports 52. The reflector supports 52 support the reflector 24 and serve as heat sinks to conduct heat out of the lamp compartment 40. In one embodiment, the reflector supports 52 are integrally cast with the main housing 12. All of the reflector supports are in physical contact with the reflector 24 for the purpose of conducting heat from the reflector. Though all of the supports are in contact with the reflector, typically, only certain of the supports will include holes 60 which accept fasteners (such as screws) which attach the reflector to the supports and thus securely hold the reflector and lamp 26 within the lamp compartment 40.

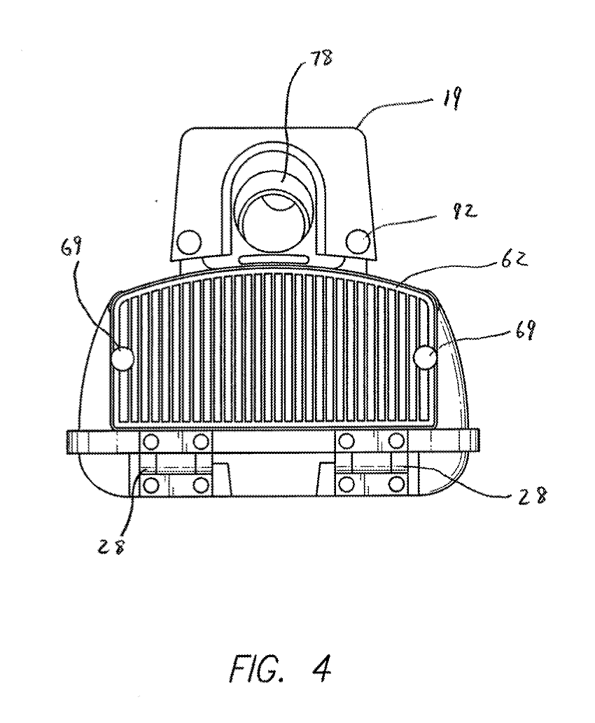

Referring now to FIG. 8, the lid 16 which closes out the lamp compartment 40 of the main housing 12 includes a light-glass 22. The light-glass 22 is secured to the lid 16 by a plurality of clamps 94, which attach to the lid by means of screws. Sandwiched between the light-glass and a supporting lip 19 formed into the lid 16 is a seal 96 which prevents water or insect intrusion into the lamp compartment through the light-glass/lid interface. The light-glass 22 may be easily removed from the lid for cleaning or replacement as the clamps 94 holding the glass to the lid require nothing more than a screwdriver or removal. The hinges 28 (best shown in FIG. 4) are sufficiently durable so as to prevent the light-glass from “flopping around” when the lid is opened.

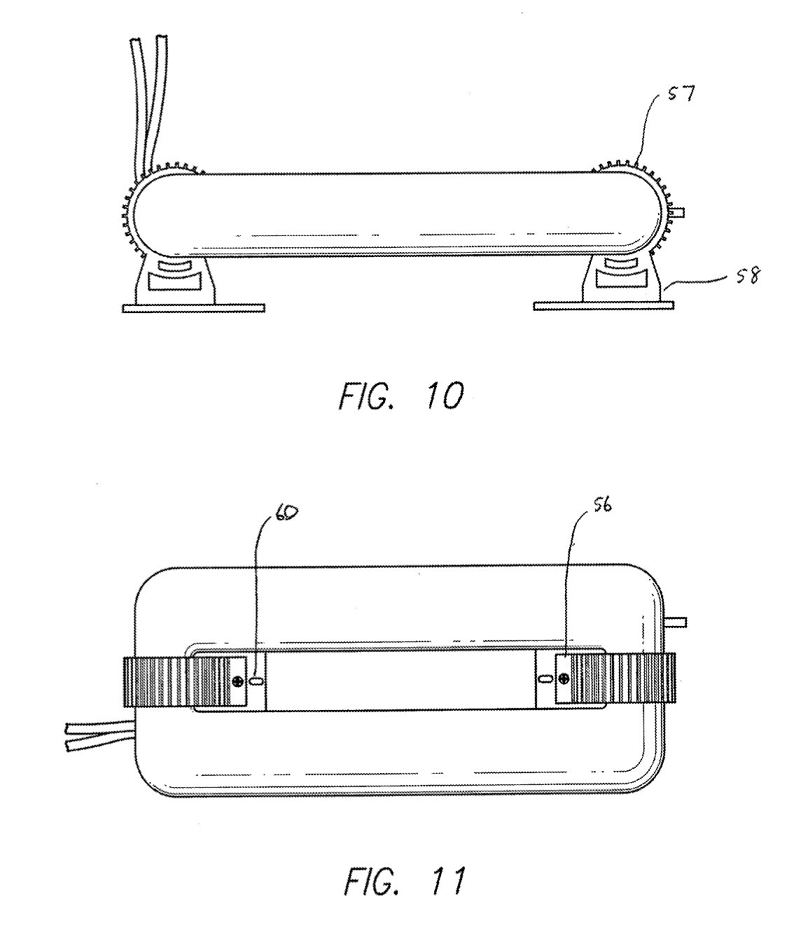

With reference to FIGS. 8-11, each lamp includes one or more lamp standoffs 54 which function to stand the lamp 26 off from the reflector 24 and to secure the lamp 26 within the lamp compartment 40. The standoffs 54 comprise a clamp assembly 56, which in one embodiment comprises a split-ring clamp, and a base portion 58 for interfacing with the reflector 24 and reflector supports 52. The lamp standoffs also include a plurality of cooling fins or ribs 57 spaced radially about the perimeter of the standoffs. (See FIG. 10.) The lamp standoffs 54 will typically be made of aluminum though other heat resistant materials such as zinc alloys and various grades of thermoplastics are suitable and known in the art. The base portion 58 of the lamp supports 54 include holes 60 which align with like holes 60 in the reflector 24 and reflector supports 52 so that the reflector and lamp, via the lamp supports, may be secured to the main housing, via the reflector supports, by one set of fasteners.

In operation, much of the heat generated by the lamp 26 is absorbed by the reflector 24 and conducted out of lamp compartment by the reflector supports/heat sinks 52. Heat is conducted from the reflector supports to the outer surface 13 of the main housing 12. Heat is transferred from the outer surface 13 of the main housing 12 to the atmosphere via convection cooling. The ambient air temperature surrounding the streetlight 10 will in virtually all cases be at a cooler temperature than the main housing after a few minutes of lamp operation. Thus, convection cooling occurs from the main housing to the atmosphere.

Referring now to FIGS. 6-7, the main housing 12 also features a ballast compartment 42. The ballast compartment 42 is separate from the lamp compartment 40 because the ballast electronics 32 are heat sensitive and it is desirable to isolate the ballast 32 from heat loading caused by the lamp 26. The inventor has found that enclosing the ballast in a compartment separate from that of the lamp substantially reduces heat loading from the lamp. The ballast compartment is closed out by a closeout 62. The closeout 62 includes cooling fins 66. The ballast 32 is mounted directly to an interior surface of the closeout 62. Heat generated by the ballast 32 is conducted through the closeout 62 and transmitted via convection, i.e. air flow past the cooling fins 66 to the atmosphere. Electrical connection between the ballast and the lamp is made via wiring which passes through a pass-through plug 70. The pass-through plug 70 may be made from a heat resistant plastic or other material that is has good thermal and electrical insulation characteristics.

The ballast 32 includes a ground wire 102. The ground wire 102 is secured to the inside of the ballast compartment to prevent removal, either accidentally or due to an act of vandalism, when the streetlight is in use.

Because the ballast 32 may occasionally fail during service and need to be replaced, the ballast closeout 62 is removably attachable to the main housing 12 via screws 64 equipped with large knobs. The knobs of the screws 64 are sufficiently large so as to allow the screws to be screwed and unscrewed without the use of tools in most instances. The ballast closeout 62 includes a weather seal 68 which encircles the periphery of the closeout 62. When the closeout is fastened to the ballast compartment 42 by the screws 64, the weather seal 68 contacts an outer edge or lip 74 of the ballast compartment 42 and thereby seals the compartment from the elements. The weather seal 68 may be made from numerous elastomeric materials as is known in the art.

With continued reference to FIGS. 6 and 7, the main housing 12 also includes a mast compartment 44. The mast compartment 44 is closed out by an upper cover 14 that is attached to the main housing 12 at one end by a hinge 20. The mast compartment 44 and associated upper cover 14 have a hinged end 98 and a mast opening or mast receipt end 100. (See FIG. 1.) The upper cover 14 features a receptacle 17 for receipt of the photocell 18. The mast compartment 44 features one or more mast-clamps 36 which accommodate the end of the mast 38. Masts used to mount streetlights are generally round tubes of varying diameters. Masts with diameters of about 1¼″ to about 2½″ are in common use in various locales in the United States. The mast-clamps 36 of the present invention streetlight 10 feature adjustability sufficient to accommodate the aforementioned range of diameters. This range of adjustability eliminates the need for streetlight installation and service crews to carry several sizes of clamps to accommodate the various diameters of masts in common use.

Located within the mast compartment 44 is the terminal block 34 which interconnects the wiring for the ballast 32, lamp 26 and photocell 18. The present invention streetlight 10 by locating the majority of the wiring inside the mast compartment eliminates the need to use multiple rubber grommets to seal the wiring.

At the hinged end 98 (see FIG. 1) of the mast compartment 44 is a protruding surface 80 which protrudes from the main housing 12 and about which is affixed a strip seal 76. At the mast receipt end 100 of the mast compartment is a mast seal 78. The mast seal 78 is attached to a raised flange 82 protruding from the outer surface 13 of the main housing 12. The mast seal includes a circular opening 84 through which the mast 38 slides when the streetlight 10 is assembled to the mast. When the upper cover 14 is closed, an inner surface 84 of the cover abuts the strip seal 76 at the hinged end 98 of the cover and seals the compartment 44 from water or insect intrusion at that end.

At the opposite or mast receipt end 100 of the cover 14 (see FIG. 1), the cover includes a flange 86 that has U-shaped opening 88. When the cover is in a closed position, the U-shaped opening 88 fits about the mast and the mast seal 78 slides inside the cover and abuts an interior surface 90 of the flange 86 of the upper cover 14. Like the ballast compartment closeout, the upper cover 14 is secured to the main housing 12 by screws 92 which are equipped with knobs that are sufficiently large to be easily removed without the use of tools in most instances. In this manner, the mast compartment is sealed from the elements and intrusion by insects and in particular by bees and wasps.

Materials and methods of manufacture to make the components of the present invention streetlight 10 are known in the art. Suitable materials for the main housing 12 include various aluminum and zinc alloys. The main housing will typically be made using a casting process. The main housing 12 may also be made from various thermoplastic materials in which instance the housing would be manufactured using a molding process. The light-glass 22 is typically made from heat resistant tempered glass. The seals used in the housing may be made from numerous elastomeric materials as is known the art. Suitable induction lamps 26 are also commercially available.

As may be seen from the above, an improved streetlight has been presented. The new streetlight features improved sealing from the elements, lower running temperatures and quicker servicing than has heretofore been available in streetlights.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover all such modifications and alternative embodiments.

What is claimed is:

1. An improved streetlight comprising:
a main housing having a lamp compartment covered by a removably attachable lid;
a ballast compartment covered by a removably attachable closeout;
a mast compartment covered by a removably attachable closeout;
the lamp compartment housing a reflector and a lamp;
the ballast compartment housing a ballast; and
the lamp and ballast being connected in electrical circuit.

2. The improved streetlight of claim 1, wherein the lamp and ballast compartments are integral to the main housing but are physically separate from each other, wherein the separate compartments provide for improved isolation of the ballast from heat generated by the lamp.

3. The improved streetlight of claim 1, wherein the lamp, ballast and mast compartment closeouts are configured to be opened and closed without the use of tools.

4. The improved streetlight of claim 1, wherein the lamp compartment includes a plurality of heat-sinks formed into the bottom of the lamp compartment, each heat-sink being in contact with the reflector, whereby heat absorbed by the reflector from the lamp is conducted by the heat-sinks to the main housing and dissipated in the atmosphere.

5. The improved streetlight of claim 1, wherein the mast compartment further includes clamps capable of attachment to a mast, wherein the clamps can be clamped to masts having a diameter within the range of 1.25 inches to 2.5 inches.

6. The improved streetlight of claim 1, wherein the closeout for the lamp compartment includes a removably replaceable light glass.

7. The improved streetlight of claim 1, wherein the closeouts for the lamp, and ballast compartments are equipped with seals to seal out the elements and insects when the closeouts are in place.

8. The improved streetlight of claim 1, wherein the mast compartment includes seals to prevent weather and insect intrusion.

9. The improved streetlight of claim 1, wherein the ballast compartment closeout is a heat-sink having an interior surface for mounting the ballast to the closeout and an exterior surface having a plurality of cooling ribs, wherein heat from the ballast is dispersed to the atmosphere by the cooling ribs.

10. The improved streetlight of claim 1, further including a photocell, mounted in the mast compartment cover, the photocell being connected in electrical circuit with the lamp and ballast.

11. An improved streetlight comprising:
a main housing having an integral lamp compartment, sealed by a hinged lid, an integral ballast compartment sealed by a removably attachable closeout and an integral mast compartment sealed by a hinged cover;
the lamp compartment housing a reflector and a lamp;
the ballast compartment housing a ballast;
the mast compartment housing clamps for receipt of a light-pole mast;
the lamp and ballast compartments being integral to the main housing but disposed so as to be physically separate from each other, wherein the separate compartments provide for improved isolation of the ballast from heat generated by the lamp;
the lamp compartment lid, ballast compartment closeout, and mast compartment cover each capable of being opened and closed without the use of tools; and the lamp and ballast being connected in electrical circuit.

12. The improved streetlight of claim 11, further including a photocell, mounted in the mast compartment cover, the photocell being connected in electrical circuit with the lamp and ballast.

13. The improved streetlight of claim 11, wherein the lid of the lamp compartment includes a removably replaceable light glass.

14. The improved streetlight of claim 11, wherein the lamp compartment includes a plurality of heat-sinks formed into the bottom of the lamp compartment, each heat-sink being in contact with the reflector, whereby heat from the lamp is absorbed by the reflector and conducted by the heat-sinks to the main housing and dissipated in the atmosphere.

15. The improved streetlight of claim 11, wherein the lid of the lamp compartment is hinged to the main housing at one end and releaseably latched to the main housing at another end.

16. The improved streetlight of claim 11, wherein the closeout for the ballast compartment acts as a heat-sink having an interior surface for mounting the ballast to the closeout and an exterior surface having a plurality of cooling ribs, whereby heat from the ballast is dispersed to the atmosphere by the cooling ribs.

17. The improved streetlight of claim 11, wherein the closeouts for the lamp, and ballast compartments are equipped with seals to seal out the weather and insects when the closeouts are in place.

18. An improved streetlight comprising:
a main housing having a lamp compartment, sealed by a hinged lid, a ballast compartment sealed by a removable closeout and a mast compartment sealed by a hinged cover;
the lamp compartment lid, ballast closeout, and mast compartment cover capable of being opened and closed without the use of tools;
the lamp compartment housing a reflector and a lamp;
the ballast compartment housing a ballast, the ballast having a ground wire connected internally within the ballast compartment;
the mast compartment cover mounting a photocell;
the lamp and ballast compartments being disposed about the main housing so as to be physically separate from each other, wherein the separate compartments isolate the ballast from heat generated by the lamp;
the lamp compartment including a plurality of heat-sinks formed into the bottom of the compartment, each heat-sink being in contact with the reflector, wherein the heat-sinks provide a conduction path for heat absorbed by the reflector to be dispersed in the atmosphere; and
the lamp, ballast and photocell being connected in electrical circuit.

19. The improved streetlight of claim 18, wherein the mast compartment further includes clamps capable of attachment to a mast, wherein the clamps can be clamped to masts having a diameter within the range of 1.25 inches to 2.5 inches and the lamp, mast and ballast compartments are equipped with seals to seal out weather and insects when the compartments are closed.

20. The improved streetlight of claim 18, wherein the lamp is spaced outwardly from the reflector by one or more lamp supports, each lamp support having a plurality of cooling fins.
